(19) United States
(12) Patent Application Publication
(10) Pub. No.: US 2015/0149367 A1
(43) Pub. Date: May 28, 2015

(54) RENTAL CASKET DISTRIBUTION SYSTEM AND METHOD

(71) Applicant: Thacker Caskets Inc., Clinton, MD (US)

(72) Inventor: Carl Justin Thacker, Fulton, MD (US)

(73) Assignee: Thacker Caskets Inc., Clinton, MD (US)

(21) Appl. No.: 14/092,456

(22) Filed: Nov. 27, 2013

(51) Int. Cl. G06Q 30/06; G06Q 10/08; G06Q 20/40; A61G 17/007

(52) U.S. Cl. CPC G06Q 30/0645; A61G 17/007; G06Q 10/083; G06Q 20/407
USPC 705/307

(57) ABSTRACT

A rental casket distribution system includes a distribution system administrator in communication with a supplier network, a distributor network and a service provider network to provide rental caskets to service providers for temporary use by a client deceased. A rental casket order is received by the administrator and dispatched to a selected distributor for fulfillment and delivery of a rental casket kit to a service provider. The rental casket kit is assembled to include a returnable, reusable rental casket and may further include one or more of a non-reusable casket insert, casket lining, pillow, and overlay. The rental casket may be customized by the distributor prior to delivery to the service provider. A rental casket price includes a rental casket deposit and a rental fee. The rental casket deposit may be partially or fully refunded as determined by the condition of the rental casket upon return to a distributor.

### TECHNICAL FIELD

The present disclosure relates to a distribution system for distribution of reusable caskets, also known as display caskets or rental caskets.

### BACKGROUND

Funeral costs are expensive and include the cost of preparing the body of the deceased, cost of a casket for presentation and/or burial of the deceased, final disposition costs such as cremation costs or interment costs including vault costs, burial costs, etc. The cost of purchasing a casket for the deceased can represent a major portion of total funeral expenses, where the purchase price of a casket may vary significantly, depending on casket style selected, the types of materials and finishes used to fabricate the casket, the level of ornamentation, the interior finishing of the casket which may include a pillow, draping, lining, a lid panel, etc. Additional costs may be incurred customizing a casket for the deceased with ornamentation, inlays, appliqués, or other embellishments to reflect preferences of the deceased or aspects of the deceased's life. For example, a casket may be customized or themed for a religious preference, a military service, a hobby or sporting interest, etc. of the deceased.

In some circumstances, in lieu of purchasing a casket for the deceased, a funeral service provider may offer a rental casket for rent to a client making arrangements on behalf of the deceased, to be used for temporary presentation of the deceased during visitation or memorial services, or in circumstances where use of a casket to contain the deceased may be temporary. For example, cremation is increasingly being used as an alternative to interment due to personal preference of the deceased or for budgetary reasons to avoid the costs of purchasing, opening, and closing a vault and burial site. In such cases, a rental casket may be used temporarily to present the deceased during visitation or memorial services, at a rental cost which is fraction of the purchase cost of the casket. During visitation or mourning, the deceased may be positioned in the rental casket on a removable tray or in a removable container referred to as a casket insert. The removable container may be, for example, a paperboard, wooden or other suitably flammable container which burns leaving little or no ash, such that the removable container may also be used as a cremation container. After presentation, the removable container including the deceased is removed from the rental casket for cremation.

In another example, the funeral service provider may offer a rental casket which may be rented for presentation of the deceased during visitation and memorial services. Prior to interment, the deceased is transferred from the rental casket to a second casket purchased for the permanent interment of the deceased. The rental casket may be a premium casket, e.g., a more highly finished or ornamented casket for dignified presentation of the deceased. The second casket may basic or modest casket, which is less highly finished than the rental casket, such that the purchase price of the second casket is appreciably less than the purchase price of the more highly finished rental casket. By using the combination of a highly finished rental casket and a purchased second less finished casket for interment, the deceased is presented with dignity in the rental casket during visitation and memorial services, and the total incurred cost including the relatively lower purchase price of the second casket and the rental fee for use of the rental casket can be appreciably less than the purchase price of the highly finished rental casket, thereby representing a cost savings to the deceased's total funeral expenses.

Rental caskets are typically purchased by a funeral service provider, which may be, for example, a funeral home, funeral parlor, or the like, and stored on location at the funeral service provider when not in use, e.g., when not rented for presentation of a deceased. A rental casket is a dedicated use, non-resalable unit typically configured as a shell to receive a removable tray, a casket insert, or other removable container which is required to contain the deceased during use of the casket rental. The funeral service provider incurs a cost to initially purchase the rental casket, and further incurs ongoing costs to store and maintain the rental casket, where storage of the rental casket may consume space at the funeral service provider location which may be otherwise usable for revenue generating purposes, for example, for stocking non-rental casket inventory salable by the service provider. Because of the initial and ongoing costs and storage requirements, a funeral service provider may elect not to offer a rental casket option. Alternatively, a funeral service provider may purchase and store only one or a very limited number of rental caskets, thus substantially limiting the type, style, finish and selection of rental caskets the funeral service provider has available for rent to a client/deceased.

### SUMMARY

A distribution system for the distribution of returnable rental caskets and a method of distributing returnable rental caskets are provided. The distribution system described herein substantially increases the availability and breadth of rental casket options which can be offered by a funeral service provider to a client, where the client, as that term is referred to herein, is the representative of the deceased making final arrangements including funeral arrangements, on behalf of the deceased, where such final arrangements include casket selection for the deceased.

The rental casket distributed by the system and method described herein may be distributed in a rental casket kit, which includes the reusable and returnable rental casket and a non-reusable casket insert. The casket insert may be configured as a cremation container such that the casket insert may be cremated with the deceased body, and/or may be configured for transfer to a vault for interment of the deceased. The rental casket kit may further include other components, such a lid panel, pillow, liner, and overlay which may be provided as a coordinated set, kitted with the rental casket for delivery to the service provider. The rental casket kit may be kitted, e.g., compiled by a warehouse distributor for delivery to the service provider using components warehoused by the warehouse distributor. The rental casket and/or rental casket kit may be customizable by the warehouse distributor to provide a customized rental casket kit, where customization by the warehouse distributor may include assembling and/or installing one or more of a liner, overlay, pillow, lid panel, casket hardware, casket ornamentation, and casket insert to a rental casket prior to shipment of the customized rental casket kit to the service provider.

The system and method for distributing a rental casket kit includes receiving an order from a service provider for rental of a rental casket kit including a reusable rental casket, providing a rental casket kit price comprising a rental fee and a rental casket deposit, dispatching the order to a fulfilling distributor, and delivering the rental casket kit to the service provider from the fulfilling distributor. The method further includes returning the rental casket to the fulfilling distributor, inspecting the returned rental casket to determine the returned condition of the rental casket, and determining a portion of the rental casket deposit refundable to the service provider based on the returned condition of the rental casket. The system includes a distributor network including a plurality of distributors, such that the method may include determining availability of the rental casket within a distributor network, and selecting the fulfilling distributor from the distributor network based on the availability of the rental casket from the fulfilling distributor. The rental casket kit includes a non-reusable casket insert which is delivered with the rental casket to the service provider from the fulfilling distributor. The rental casket kit may further include one or more non-reusable components such as one or more of a casket lining, a casket pillow, and a casket overlay. In one example, the method includes delivering the rental casket kit including the non-reusable component to the service provider from the fulfilling distributor, where the fulfilling distributor may assemble non-reusable components including the casket insert in the rental casket for packaging efficiencies prior to delivery to the service provider. The rental casket may be a customized rental casket, wherein customizing the rental casket includes customizing at least one of a swing bar, a swing bar mount, a corner element, and an inlay of the rental casket. Additional components, such as the overlay, a lid panel, etc. may be customized and may coordinate with the customized features of the rental casket.

The distribution system may include an enterprise resource planning (ERP) system in communication with the administrative system and the distributor network, such that orders for rental casket kits are received into the ERP system and administered through the ERP system. The ERP system may associate an inventory status identifier with each rental casket in the distribution network, and modify the inventory status identifier of the rental casket to indicate completion of at least one of order dispatch, order delivery, rental casket return, and rental casket inspection or other steps in the distribution method as described herein. The ERP system tracks inventory of rental caskets and non-reusable components in the distributor network, which includes modifying the inventory quantity of the non-reusable components to indicate delivery of the non-reusable components to the service provider, and removing scrapped or non-returned rental caskets from inventory, and may further include issuing replenishment orders to a supplier network to replenish depleted inventories of the non-reusable components and/or rental caskets.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic perspective view of an exemplary rental casket kit including a rental casket and a casket insert in display position in the rental;

FIG. 2 is an schematic perspective view of the exemplary rental casket kit of FIG. 1 showing a moveable panel section of the rental casket in the open position for receiving the casket insert into the rental casket;

FIG. 3 is a schematic illustration diagram of an exemplary system for distribution of rental caskets such as the exemplary rental casket shown in FIGS. 1 and 2; and

FIG. 4 is a schematic flow chart diagram of an exemplary method for distributing rental caskets such as the exemplary rental casket shown in FIGS. 1 and 2.

### DETAILED DESCRIPTION

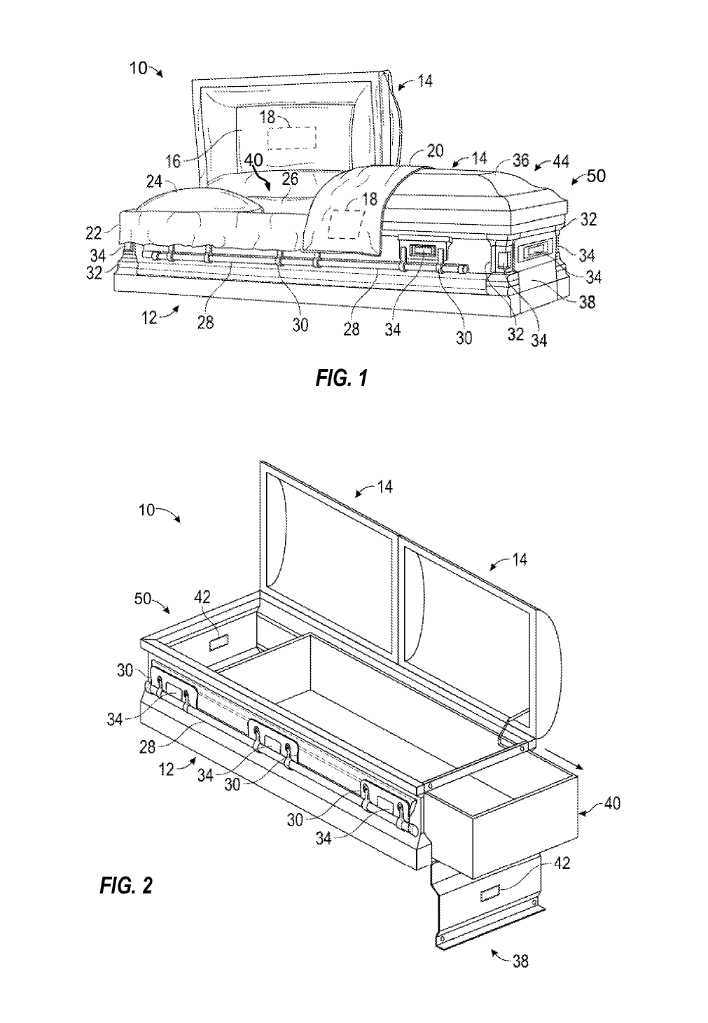

Referring to the drawings wherein like reference numbers represent like components throughout the several figures, the elements shown in FIGS. 1-4 are not necessarily to scale or proportion. Accordingly, the particular dimensions and applications provided in the drawings presented herein are not to be considered limiting. Where relative terms such as “side,” “end,” “upper,” “lower,” “above,” “below,” “top,” “bottom,” “vertical,” “horizontal,” “longitudinal,” “lengthwise,” and “transverse” are used herein and in the claims, these terms are intended be relative to the orientation of the casket 50 and/or casket 50 in the display position and/or relative to the deceased in the display position.

A distribution system 60 for the distribution of returnable rental caskets 50 and a method 100 of distributing returnable and reusable rental caskets 50 are provided. The distribution system 60 described herein substantially increases the availability and breadth of rental casket options which can be offered by a funeral service provider to a client or client deceased, where the “client” or “client deceased” as those terms is referred to herein, is the deceased who has prearranged or previously provided for final arrangements, or a representative of the deceased making final arrangements, on behalf of the deceased, where such final arrangements include funeral arrangements including casket selection for the deceased.

The rental casket 50 distributed by the system 60 and method 100 described herein may be distributed as a component of a rental casket kit 10. The rental casket distribution system 60 includes an administrative system 48 also referred to herein as an administrator 48, a plurality of distributors 52 also referred to herein as warehouse distributors, a plurality of funeral service providers 54, in communication with each other such that a rental casket kit 10 including a rental casket 50 may be ordered by a service provider through the administrator 48, and the order dispatched to a distributor for fulfillment and delivery of the casket kit 10 to the service provider in a timely manner, e.g., in the time frame in which the rental casket 50 is required by the service provider for presentation and display of the deceased during visitation and/or memorial services. A variety of different models of rental casket 50 may be stocked in the network of distributors 52 along with a variety of casket kits 10 and casket kit components such that a variety of casket kit 10 combinations may be offered to meet the requirement and/or wants of a broad client group 58. In one example, the rental casket 50 and other components of the rental casket kit 10 may be customized for the client deceased from a selection of available options, which may include, for example, model, size, material, color, finish, trim, and/or embellishment options for the rental casket 50 and components of the rental casket kit 10 as described further herein.

An exemplary rental casket kit 10 is shown in FIGS. 1 and 2 and generally indicated at 10. A rental casket kit 10, also referred to herein as a casket kit 10, includes a rental casket generally indicated at 50 and a non-reusable (single use) casket insert 40 shown in FIG. 2 and generally indicated at 40. The rental casket 50 may also be referred to herein as a reusable casket 50 or as a display casket 50. The casket insert 40 is configured to contain a deceased body (not shown, also referred to herein as the deceased) prepared for cremation or interment and positioned in the casket insert 40 for display or presentation during visitation and/or memorial services, prior to interment or cremation. The casket insert 40 may be configured as a cremation container such that the casket insert 40 may be cremated with the deceased body, and/or may be configured for transfer to a vault for interment of the deceased. The casket insert 40 containing the deceased body is placed temporarily in the rental casket 50 for display or presentation of the deceased, and may be inserted into and removed from the rental casket 50 via an opening in the casket box 12 of the rental casket 50 provided for that purpose. In the present example shown in FIGS. 1 and 2, the casket box 12 may include an access door 38 configured as a rotatable end panel 38, which may be selectively opened when required to insert or remove the casket insert 40 from the casket box 12. By way of non-limiting example, the rental casket 50 may be configured as a reusable rental casket 50 as described in U.S. patent application Ser. No. 14/065,836 filed Oct. 29, 2013 by the inventor.

In the example shown, the rental casket 50 includes a casket box 12 which can be enclosed with head and foot lids 14, which may be individually pivotable between an open and closed position. The rental casket 50 may be made in a variety of models, styles, shapes, materials, finishes, sizes and with various options for ornamentation and/or trim packages. In the example provided, a plurality of rental caskets 50 of different models, styles, shapes, materials, finished and sizes may be made available, e.g., placed in inventory and/or stocked at one or more warehouse distributors 52, for distribution through the distribution system 60 and method 100 described herein to one or more funeral service providers 54. As such, rental caskets 50 of varying configurations are available for distribution through the system 60 and the method 100 described herein to satisfy a broad and diversified base of client needs and desires. By way of non-limiting example, the rental caskets 50 may be made available in a variety of casket materials 44 which may include wood materials of different varieties such as mahogany, walnut, oak, cherry, pecan, maple, etc., and/or metal materials of different types such as bronze, stainless steel, copper, etc. A variety of surface finishes may be made available to finish the casket surface 36, which may include, by way of non-limiting example, brush, polished, satin, gloss, stained, painted, coated or other type finishes.

The interior of the casket lid 14 may be domed to receive a lid panel 16 configured to fit into the casket lid 14 and cover the inside surface of the casket lid 14. The lid panel 16 may be covered with cloth or other material which may be of a type, color and style to complement the cloth of a casket lining 26, drop 22 and overlay 20. The lid panel 16 may be decorated, for example, with an embellishment 18 which may be, by way of non-limiting example, an applique, embroidery, pleating, ruching, or other decorative detail, or may be functional including a shelf or attachment for displaying a flower vase, picture frame, religious item, etc. The rental casket kit 10 may further include other components, such a pillow 24, lining 26, a drop 22, and an overlay 20, as shown in FIG. 1, which may be non-returnable and non-reusable components of the rental casket kit 10. The lining 26 lines the interior of the casket insert 40 to cover the interior surfaces of the casket insert 40 and the casket box 12, and to provide an aesthetically pleasing surface upon which the deceased is positioned. With the casket 50 in the open position, e.g., with the casket lid 14 raised, the lining 26 may be extended from the casket insert 40 over the side of the casket box 12 to provide an integral drop 22 (see FIG. 1) such that the transition between the casket box 12 and the casket insert 40 is covered and not visible during presentation of the deceased. Each of the lining 26, the overlay 20 and the pillow 24 may be made of cloth or other material and may be coordinated by color, material type, embellishment 18, finishing, or other detail with each other and/or with the lid panel 16. Two or more of the lid panel 16, overlay 20, pillow 24 and lining 26 may be provided as a coordinated set. The embellishments 18 may be customized or themed for a religious preference, a military service, a hobby or sporting interest, etc. of the deceased, or with a phrase, symbol, or image associated with a client deceased, where these examples are non-limiting. By way of example, the casket 50 lining 26, lid panel 16, pillow 24, and/or overlay 20 may be made of a fabric which may be a polymer based or organic material, and may be colored, decorated, trimmed, finished and/or embellished to provide an aesthetically pleasing appearance.

In the example shown in FIG. 1, the casket 50 includes swing bars 28 extending the longitudinal length of the casket 50 sides. The swing bar 28 is attached to a plurality of swing bar mounts 30 which are attached to the casket box 12. The swing bar 28 may be hingably fixed to the swing bar mounts 30 such that the swing bar 28 can be extended away from the casket box 12 and used to manually lift and transport the casket 50. The swing bar mounts 30 may be customized for the style of the casket 50, and may be decorated and/or include a decorative inlay 34. The inlays 34 may be removable and replaceable such that the swing bar mounts 30 may be customized by changing the type and style of the inlay 34 installed in the mounts 30. The swing bar mount 30 and/or inlay 34 may be themed to the style of the casket 50, may be coordinated with the embellishment 18 on the lid panel 16 and/or the overlay 20, or may otherwise be finished to provide an aesthetically pleasing appearance. The casket box 12 may be further decorated by corner elements 32 which may be coordinated, for example, with the swing bar mounts 30. The corner elements 32 may include decorative inlays 34, which may coordinate with the inlays 34 of the swing bar mounts 30 and/or the embellishment 18 on the lid panel 16 or overlay 20, and which may be removable and replaceable such that the corner elements 32 can be customized. The rental casket 50 and the swing bar 28, swing bar mounts 30 and/or the corner elements 32 may be configured such that the swing bar 28, swing bar mounts 30 and/or the corner elements 32 may be removable and replaceable with swing bars 28, swing bar mounts 30 and/or corner elements 32 having a different style, finish, etc., such that the rental casket 50 may be customized.

The rental casket 50 may include one or more identifying elements 42 including identifying information configured to identify each rental casket 50 individually, which may be affixed to the rental casket 50 in one or more locations convenient for reading, scanning, or detection during inventory management activities which may include manufacturing, assembly, storage, shipping, delivery, pick-up and the like. The identifying element 42 may be, by way of non-limiting example, a plate, a sticker, a label, a tag or other item which may be affixed to the rental casket 50, or may be configured as identifying information integral to the rental casket 50, such as a serial number stamped or etched on the rental casket 50. The identifying element 42 may include, for example, a bar code which may be readable visually and/or by a bar code scanner, a non-contact or wireless identifying element 42 such as a radio frequency identification (RFID) tag, which may be read by an RFID reader or other non-contact device, etc. The identifying element 42 may be readable by whatever means suitable to the configuration of the identifying element 42, which may include visual observation, use of a scanner as in the case of a bar code label 42, wireless or non-contact detection as in the case of an RFID tag 42 or other non-contact device.

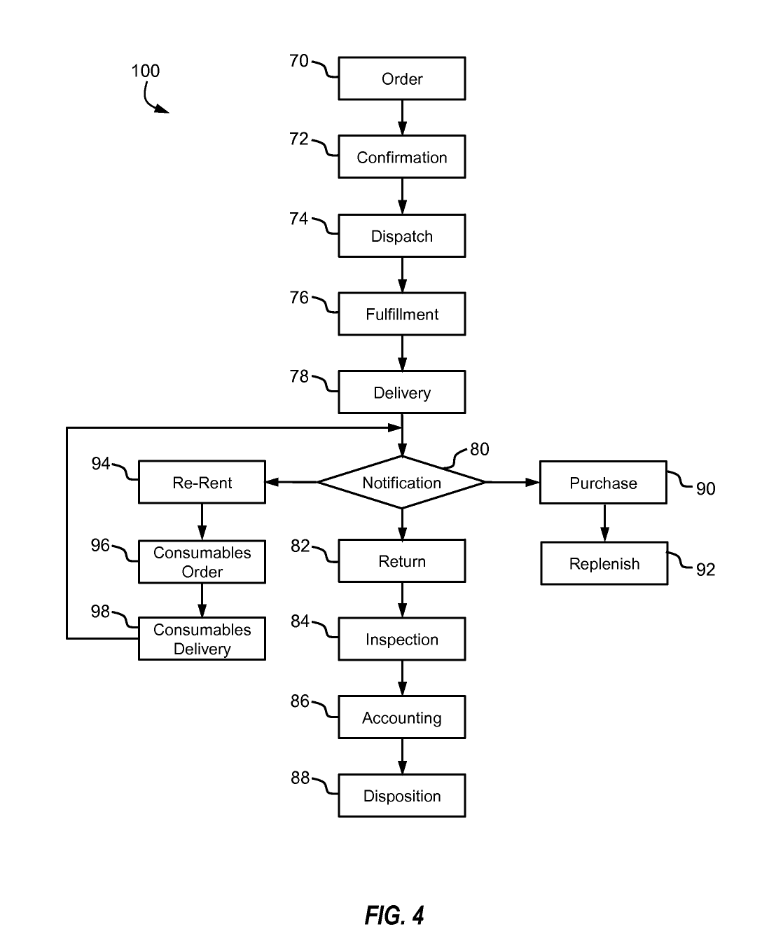

The identifying information may be included in the identifying element 42, for example, as a part number, serial number, color, model number, etc., printed on or recorded in the identifying element 42, and/or may be retrievable from another source, such as an enterprise resource planning (ERP) database 68 or other cross-reference, which may be a digital or paper cross-reference, by a reference number, such as a serial number, retrievable from the identifying element 42. The identifying information may be specific to the rental casket 50 and include, by way of example, one or more of the style, shape, model, material, finish, and size of the rental casket 50. The identifying information may include, for example, details of the trim features of the rental casket 50, where the trim features may include the swing bar 28 type and finish, the swing bar mount 30 type, the corner element 32 type, etc. The identifying element 42 may further include information specific to a casket kit 10 including the rental casket 50 serial number unique to that specific rental casket, and including information such as the casket insert 40 type, model and/or insert 40 material, the style, type, color, material, embellishment 18 information for one or more of a lining 26, overlay 20, pillow 24, and/or lid panel 16 included with the casket kit 10, etc. The identifying element 42 may include a plurality of identifying elements 42, each specific to a component of the casket kit 10 and identifiable to a casket kit identifier used for tracking the casket kit 10 during the distribution of that casket kit 10. The casket kit identifier may also be referred to herein as a casket kit tracking reference or a kit tracking number, which may be an order number. For example, one or more of the rental casket 50, the casket insert 40, the lid panel 16, the swing bar 28, the swing bar mounts 30 and/or the corner elements 32 may be separately identified with an identifying element 42. The identifying element 42 of these returnable elements 32, 42 may include a part or model number and may further include identifying information which is unique to that particular component, such as a serial number of the rental casket 50, or a set number identifying each corner element 32 as one of a set. Consumable, e.g., non-returnable components of the rental casket kit 10 including the overlay 20, the lining 26 including the drop 22, and the pillow 24, may be identified with an identifying element 42 showing, for example, a part number, style number or model number. A casket kit identifier, tracking number, or order number may be recorded and associated with the identifying information from each component of the casket kit 10 in an ERP system 64 or database 68 or other cross-reference, which may be a paper or paperless cross-reference, for tracking the casket kit 10 through the steps of the method 100 shown in FIG. 4.

The rental casket kit 10 may be kitted, e.g., compiled by a warehouse distributor for delivery to the funeral service provider Px using components warehoused by the warehouse distributor Dx. The rental casket 50 and/or rental casket kit 10 may be customizable by the warehouse distributor Dx to provide a customized rental casket kit 10, where customization by the warehouse distributor Dx may include assembling and/or installing one or more of a liner 26, overlay 20, pillow 24, lid panel 16, casket 50 hardware, casket 50 ornamentation, and casket insert 40 to a rental casket 50 prior to shipment of the customized rental casket kit 10 to the service provider Px. The casket insert 40 may be made of a variety of different materials, and may be a crematable or non-crematable insert, the latter, for example, for use when transferring the deceased from the rental casket 50 after presentation to another container such as a vault for interment. The rental casket 50 may be customizable by the warehouse distributor by assembly of one or more of swing bars 28, swing bar mounts 30, corner elements 32, or other customizable hardware, such as handles, latches, etc., attachable to the rental casket 50. The warehouse distributor may maintain a variety of rental caskets 50, linings 26, overlays 20, pillows 24, lid panels 16, casket inserts 40, swing bars 28, swing bar mounts 30, corner elements 32, inlays 34, etc., in stock for the purpose of customizing a selected rental casket 50 prior to shipment to a service provider Px.

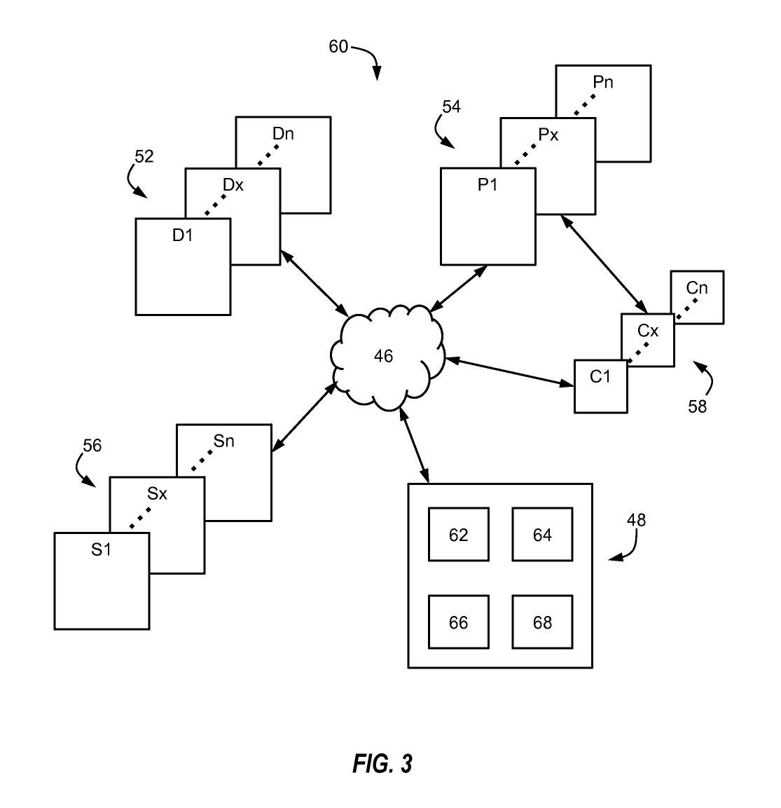

FIG. 3 illustrates an exemplary distribution system 60 for the distribution of rental caskets 50 and/or rental casket kits 10. In a non-limiting example, the exemplary distribution system 60 may be computer implemented, as described herein. Alternately, at least some of the distribution system 60 features and functions may be partially computer implemented or non-computerized within the scope of the distribution system 60 and methods described herein. The distribution system 60 includes a distribution system administrator generally indicated at 60 and also referred to herein as an administrator, a supplier network generally indicated at 56 including a plurality of suppliers S1 . . . Sn, a distributor network generally indicated at 52 including a plurality of distributors D1 . . . Dn, and a provider network generally indicated at 54 including a plurality of providers Pa . . . Pn, in communication though a communication network 46 to serve a plurality of clients C1 . . . Cn generally indicated at 58. An individual supplier of the supplier network 56 may be referred to herein as a supplier Sx, an individual distributor of the distributor network 52 may be identified as a distributor Dx, an individual provider of the provider network 54 may be identified as a provider Px, and an individual client, also referred to herein as a client deceased, may be identified as a client Cx. The communication network 46 may be a computerized or non-computerized communication network 46. In the example shown, the communication network 46 includes, for example, a computer-implemented communication network 46 such as the Internet, and may further include telephone, facsimile and other communication networks 46 including mail delivery systems and the like. The illustration shown in FIG. 3 is not intended to be limiting, and it is understood that an entity may perform more than one role in the system 60. For example, the administrator 48 may also be one or more of a distributor Dx, a supplier Sx, and a service provider Px. A plurality of funeral service providers may be operated by a single entity. Similarly, a plurality of distributors 52 may be operated by a single entity.

A funeral service provider Px, which may also be referred to herein as a service provider or a provider, may be, for example, a funeral director, a funeral home 54, a funeral parlor or other entity which provides final arrangements and/or funeral services to a client deceased Cx, including, in the present example, temporarily providing a rental casket 50 to the client Cx for display and presentation of the client deceased Cx during visitation and/or memorial services, where the rental casket 50 is provided to the client deceased Cx for the duration of the funeral event for a usage fee, at which time the deceased is removed from the rental casket 50, and the rental casket 50, if owned by the service provider Px, is retained by the service provider Px for reuse, or, in the present example, if rented by the service provider Px from a distributor Dx, is returned to the distributor Dx for redistribution and reuse. A supplier Sx may be a manufacturer 56 and/or a wholesaler of the goods (caskets, inserts 40, lid panels 16, pillows 24, etc.) supplied by that supplier Sx. In the example shown, at least one of the suppliers 56 is a casket manufacturer capable of manufacturing rental caskets 50 of the type shown in FIGS. 1-2, where the rental casket 50 is configured to temporarily contain a casket insert 40 such that the rental casket 50 is reusable. A distributor Dx may also be referred to herein as a warehouse distributor. Each distributor Dx in the distributor network 52 maintains an inventory of rental caskets 50 and related components for distribution to service providers P1 . . . Pn in the provider network 54.

The administrative system 48 includes a server 62, a memory 66, a database 68, and a distribution control system 60 generally shown as an enterprise resource planning (ERP) system 64 for control of the distribution system 60. In the example shown, the ERP system 64 is configured as a software system 60 and is computer-implemented, although it would be understood that such a system 60 could be implemented using non-computer or partially computer-based means. The ERP system 64 may include one or more ERP modules (not shown) and/or algorithms to perform distribution system 60 functions including the distribution system 60 functions shown in FIG. 4 and described herein. By way of non-limiting example, the ERP system 64 is configured and/or includes ERP modules related to order receipt, entry, confirmation and dispatch, fulfillment and delivery, pick-up and return management including inspection, billing and accounting, resource planning and demand forecasting, inventory management, purchasing and supplier 56 management, sales management, etc. The database 68 is stored in the memory 66, and may include, for example, data related to inventory including inventory quantity and status, including the status of rental caskets 50 in the system 60 (in stock, in transit, in use, in repair, on order, etc.), casket kit 10 identifiers, casket 50 component identifying information, accounting, pricing, and cost data, and other data of the type required to perform distribution system 60 functions including the distribution system 60 functions shown in FIG. 4 and described herein. The memory 66 may include, by way of example, Read Only Memory (ROM), Random Access Memory (RAM), electrically-erasable programmable read only memory (EEPROM), etc., i.e., non-transient tangible machine memory 66 of a configuration, size and/or speed sufficient for executing the ERP system 64, storing one or more data bases, providing a data repository, and/or recording, by way of example, inputs including identifying information of a casket kit 10 which may include a kit 10 identifier and/or identifying information from one or more kit 10 components. The server 62 may include a central processing unit (not shown) and may be configured as a plurality of servers 62 in communication with each other, where the plurality of servers 62 may or may not be co-located, and each of the plurality of servers 62 may be configured to perform some or all of the functions required for performance of the system 60 and method 100 shown in FIGS. 3 and 4 and described herein.

Referring now to FIG. 4, an exemplary method for distribution of rental caskets and/or rental casket kits is generally indicated at 100. The exemplary method 100 described herein is illustrative and non-limiting, and it would be understood that the method 100 may include more or less steps or events than illustrated and the ordering of steps or events is non-limiting, e.g., the order of some steps or events may be modified and/or some steps or events may occur concurrently with other steps. At step 70, an order for a rental casket 50 or rental casket kit 10 is placed by a provider Px on behalf of a client Cx with the administrator 48, and the administrator 48 forwards the order to a distributor selected from the distributor network 52 for fulfillment. The distributor Dx receiving the order may be selected by the administrator 48, for example, based on proximity to the provider Px placing the order, the inventory on hand at the distributor Dx, etc. The example is non-limiting, and other configurations are possible. For example, each provider Px may be associated with a primary distributor D1 and/or a secondary distributor D2, selected by the provider Px or based on other criteria such as geographic proximity to the provider Px. The provider Px may submit an order directly to one of the distributors D1, D2 assigned to the provider Px, instead of submitting the order to the administrator 48. In this case, the administrator 48 may have visibility through the system 60 and communication network 46 to the order history between provider Px and the distributors D1, D2 for purposes of performing demand forecasting, replenishing distributor inventory, accounting, purchasing, and the like.

By way of example, the distribution system 60 can include a plurality of distributors 52 geographically dispersed such that each one of the distributors D1 . . . Dn is located proximate to a sub-group of the service providers C1 . . . Cn, such that delivery of a casket kit 10 from the distributor Dx to any one of the service providers Cx in the distributor Dx's sub-group is feasible within a delivery objective for that distributor Dx, e.g., can be accomplished within a delivery time frame, assuming the distributor Dx has the ordered rental casket 50 and the ordered kit components in inventory to assembly the rental casket kit 10, and assuming normal delivery conditions, e.g., no extraordinary traffic or extreme weather conditions, the provider location generally accessible by primary roadways, etc. It would be understood that delivery of the rental casket kit 10 to the service provider Px as expeditiously as possible would be expected to meet client expectations, e.g., such that preparation of the deceased for presentation proceeds expeditiously for visitation and memorial services to occur as soon as possible following the death of the client deceased. Generally, the delivery objective for delivery of the rental casket kit 10 would be within seven (7) business days, or preferably within five (5) business days, or more preferably, within one to three (1 to 3) business days after order receipt and confirmation. In one example, a provider Px may be associated with a primary distributor D1 and a secondary distributor D2, where, for example, the primary distributor is closer geographically to the provider Px than the secondary distributor D2, to facilitate delivery of a rental casket kit to the provider Px within the delivery objective. For example, the primary distributor D1 may be located within a distance from the provider Px such that delivery from the primary distributor D1 is feasible within five (5) business days and preferably within one to three (1 to 3) business days. The secondary distributor D2 is further away geographically to the provider Px such that delivery of the rental casket kit 10 from the secondary distributor D2 to the service provider Px is feasible within seven (7) business days, or preferably within three to five (3 to 5) business days, or more preferably within one to three (1 to 3) business days, for example, when the primary distributor D1 is unable to fulfill the order requirements. The delivery objectives for a primary distributor D1 and/or for a secondary distributor D2 are exemplary and for illustrative purposes, and may be varied based on client expectations, geographic region, distributor density and proximity to service providers in a distribution region, etc. By way of a non-limiting example, in a densely populated region such as a metropolitan area, the distribution system 60 may be configured to support a primary delivery objective of delivery within two business days from a primary distributor D1, and a secondary delivery objective of delivery within four business days from a secondary distributor D2. By way of non-limiting example, in a sparsely populated region, for example, a primary delivery objective of three to five business days and a secondary delivery objective of less than seven business days may be standard and/or within client expectations.

The order includes ordering information which is used by the administrator 48 to determine availability of the rental casket 50 and/or the rental casket kit 10 being ordered by the service provider Px. Ordering information will include, for example, the delivery location which may be a funeral home 54 operated by or affiliated with the service provider Px, a requested delivery date and time, and a rental period specifying the length of time the provider Px will retain possession of the returnable rental casket 50 and other returnable components of the casket kit 10, such as the lid panel 16. The ordering information will detail the rental casket 50 being ordered, for example, by specifying one or more of the model, type, size, material, finish, color, trim including swing bar 28, swing bar mount 30, and corner element 32 selections. The ordering information will further detail if a casket insert 40 is required, and specify the type, size, material, etc. of the casket insert 40 being ordered. It would be understood that a provider Px may maintain one or more casket inserts 40 in inventory at the provider Px's location, for example, such that preparation of the deceased may proceed at the provider Px's location, while the provider Px awaits delivery of the rental casket 50. The provider Px may, in this event, may order a casket insert 40 from a distributor Dx with the casket kit 10 to replenish the provider Px's on-location inventory of casket inserts 40, or may order casket insert(s) 40 separately. The ordering information will further detail the model or identifying part number of lining 26, lid panel 16, overlay 20, and pillow 24 required, which may include detailing the type, material, color, finish, embellishment 18, etc. of each, as described previously. The distribution system 60 may present preconfigured casket kits 10 to the provider Px for selection during the ordering process, where each of the casket kits 10 includes a rental casket 50 and coordinated components including for example, a casket insert 40 including a coordinated lining 26, lid panel 16, overlay 20 and pillow 24, and ordering is simplified by selecting one of the preconfigured casket kits 10, which may be identified by its own kit model number. Alternatively, a preconfigured casket kit 10 may be selected and partially modified for customization for the client Cx, for example, by changing the lid panel 16 of the preconfigured kit to a differently embellished lid panel 16 or selecting between two different color offerings for the lining 26, overlay 20 and pillow 24 materials. The ordering step may include the provider Px identifying a preferred distributor Dx for order fulfillment. The order is submitted and the method 100 proceeds to step 72.

Other alternatives or options for ordering step 70 may be included in the distribution method and system. For example, the provider Px may be presented with menu selections which may include a number of preconfigured, e.g., standard casket kits which are not customizable, or which have limited customization options. The provider Px may be required to initially enter a requested delivery date and time or delivery window, a rental period, and a delivery location, and the administrative system may respond by presenting the rental casket kits 10 or rental casket 50 options which are available for the requested delivery date and time, the requested rental period, and requested delivery location from one or more distributors Dx geographically proximate to the ordering provider Px. The service provider Px orders an available casket kit 10 or may present this information to the client Cx, and then submit an order for an available rental casket option based on the client Cx's preferences. The administrative system 48 may be configured to present additional availability, for example, rental casket kits 10 which are available from less proximate distributors with payment of an expediting or premium delivery fee. Step 70 concludes with the provider Px entering the order, at which time the order may be assigned an order number and shown as “pending” in the ERP system 64 and database 68.

At step 72, the administrator 48 acknowledges order receipt and validates availability of the ordered casket kit 10 based on information current in the ERP database 68, including distributor inventory information. Inventory information may include, for example, information showing the quantity and type of rental caskets 50 available at a distributor location, and the inventory status of each of those rental caskets 50. By way of non-limiting example, a specific rental casket 50 may be indicated in the ERP system 64 and database 68 as one of “in stock/available” where the rental casket 50 is in stock at the distributors location and available for shipment to a provider Px, “in stock/ordered” where the rental casket 50 has been ordered but not yet pulled from inventory for shipment, “in transit outbound” where the rental casket 50 is in transit to a provider Px under another order, “rented” where the rental casket 50 is rented to a provider Px and located at the provider Px's location, “in transit inbound” where the rental casket 50 is in transit being returned from a provider Px to the distributor Dx, “in inspection” where the rental casket 50 has been returned from a rental period and is awaiting inspection to determine whether the rental casket 50 requires refurbishment or repair prior to restocking as “in stock/available” at the distributor location. Other inventory status identifiers may include, for example, “purchased” where a provider Px has purchased the rental casket 50 from the distributor Dx and is permanently removed from inventory, where typically a replacement unit will be reordered from a supplier Sx by the distributor Dx; “scrapped” where a rental casket 50 has incurred damage and is permanently removed from inventory; “in repair” or “in refurbishment” where a returned casket 50 unit requires repair or refurbishment, which may include cleaning the returned rental unit prior to reuse, repairing handling damage or other damage to the casket 50 components or finish, removing and/or replacing customized trim components with standard components, such that the specific casket 50 unit is temporarily unavailable for reuse. These inventory status identifiers are provided for illustrative use, and fewer, additional, or equivalent status identifiers may be substituted within the scope of the systems 60 and method 100 described herein. Confirmation of the order may include validating the casket kit 10 and/or the casket kit 10 components are in stock and available in a selected distributor Dx's inventory using the ERP system 64 and database 68, and may further include contacting the selected distributor Dx to request confirmation of availability of the ordered casket kit 10 and acceptance of the requested delivery date and time by the selected distributor Dx via the communication network 46. In the event availability and/or the requested delivery date and time of the ordered casket kit 10 cannot be confirmed by the selected distributor Dx, either the order is forwarded to a secondary distributor D2 for confirmation, or a response is sent by the administrator 48 to the provider Px which may notify the provider Px which components are not available such that substitutions may be selected and ordered by the provider Px, where the notification may propose at least one alternative available casket kit 10 for ordering by the provider Px. Once confirmation of availability of the ordered casket kit 10 is obtained from a distributor Dx (which may be a primary distributor or a secondary distributor D2), the confirmation step 72 continues with communication of a rental casket kit price to the provider Px.

The casket kit price includes refundable deposits and non-refundable prices and fees, and may be fully payable or chargeable to a service provider Px in advance, for example, at time of order confirmation or at time of acceptance of delivery of the casket kit 10 by the service provider Px. By way of example, the casket kit price includes a refundable rental casket deposit and a non-refundable rental fee for rental of the rental casket 50 by the provider Px for use by the client deceased Cx. In one example, the rental fee may be a portion of the purchase cost of a new non-rental casket 50, for example, less than one-half the purchase cost of a non-rental casket 50, or preferably less than one-third the purchase cost of a non-rental casket 50. In a non-limiting example, the refundable rental casket deposit may be approximately the same amount as the purchase price of the rental casket 50 for purchase of the rental casket 50 by the service provider Px. In another example, the rental casket deposit may be at least 80% of the purchase price of the rental casket 50 to the service provider Px, and preferable, at least 90% of the purchase price of the rental casket 50, to incentivize care taken to prevent damage to the rental casket 50 and return of the rental casket 50 within the specified return period following the rental period.

The amount of the rental casket deposit refunded to the provider Px after return of the rental casket 50 to the distributor Dx may be adjusted after completion of the return step 82 and the inspection step 84, and during the accounting step 86, such that the rental casket deposit may be only partially refunded to the provider Px at the disposition step 88. For example, the cost of repairs made to the returned rental casket 50 for damage incurred while under the control of the provider Px may be deducted from the rental casket deposit. Deductions may be made to the rental casket deposit for non-return of returnable components of the casket kit 10, for example, for non-return of a lid panel 16 or when cleaning or repair of a reusable component such as the lid panel 16 is required in excess of normal maintenance. Deductions may be made to the rental casket deposit for late fees incurred if the rental unit is not available for pick-up until after the return period following the rental period. The provider Px may completely forfeit the rental casket deposit, for example, in the event of irreparable damage to the rental casket 50 or failure to return the rental casket 50 to the distributor Dx.

The casket insert 40, casket lining 26, which may be integral to the casket insert 40 and include the drop 22, the overlay 20 and the pillow 24 are non-reusable components which may be purchased for inclusion with the rental casket 50 to form a rental casket kit 10. The purchase price of these non-reusable components included in the rental casket kit 10 purchased from the distributor Dx is included in the rental casket kit price as a non-refundable portion of the rental casket kit price. Alternatively, as described previously, the service provider Px may provide the casket insert 40 and lining 26, for example, from an inventory of components previously purchased by the service provider Px from the distributor Dx or elsewhere, and maintained at the provider Px's location such that preparation of the deceased for presentation may proceed prior to delivery of the ordered rental casket 50 to the provider Px. The service provider Px may advance purchase the remaining non-reusable components of the rental casket kit 10, for example, the pillow 24 and overlay 20, such that in this event the rental casket kit 10 rented from the distributor Dx by the provider Px includes the rental casket 50 and a reusable lid panel 16.

The rental casket kit price may include other non-refundable fees or charges. For example, the rental casket 50 may be ordered as a customized rental casket 50, which may require the distributor Dx to customize the rental casket 50 by installing custom components such as a customized lid panel 16, inlays 34, corner elements 32, embellished overlay 20, etc., and/or remove standard items of the rental casket 50 as it is maintained in stock and replace the removed items with customized items, such that the rental casket kit price may include a customization fee for the customization labor and for any non-reusable customized components included in the customized casket kit 10. The rental casket kit price may further include expediting or premium delivery charges, for example, where expedited delivery is requested or where the provider location necessitates use of non-standard transportation for delivery.

Continuing with step 72, availability of the rental casket kit 10, the distributor Dx's delivery estimate, and the rental casket kit price are communicated to the provider Px. Upon confirmation of the order by the provider Px, including acceptance of the rental casket kit price and the delivery estimate, the order status may be updated in the ERP system 64 from “pending” to “confirmed.” The inventory status of the rental casket 50 and the components of the rental casket kit 10 at the distributor Dx which have been ordered may be updated in the ERP system 64 from “in stock/available” to “in stock/on order,” and the method 100 proceeds to step 74.

At step 74, the confirmed order is dispatched by the administrator 48 to the distributor Dx and the order status may be updated in the ERP system 64 from “confirmed” to “dispatched.” The distributor Dx may generate a work order or pick list (not shown) using the order details, and schedule the order for fulfillment. The work order or pick list, in one example, may include a listing of serial numbers and/or part numbers identifying the rental casket 50 model and/or components which must be assembled to form the ordered rental casket kit 10. In one example, the work order may include bar codes which must be matched to the components being picked from inventory using a bar code scanner or other suitable means. In another example, the work order may include identifying elements 42, such as labels, bar codes, RFID tags, etc., which may be affixed to the rental casket 50 and to other components of the rental casket kit 10 as these components are picked from inventory and/or assembled to form the rental casket kit 10. The work order or pick list may be generated as a printed document or displayed, for example, on a portable user device (not shown) such as a tablet, personal digital assistant (PDA), smart phone or the like, which may be in communication with the ERP system 64 such that the order status may be updated in the ERP system 64 in real time as the order is processed by the distributor Dx, and such that the order status is accessible in real time by the administrator 48 and/or the ordering provider Px.

At step 76, the distributor Dx assembles the rental casket 50 and the components of the rental casket kit 10 as required by the order, which may include affixing an identifying element 42, which may be the label 42, bar code, RFID tag 42, etc. generated at step 74, to the rental casket 50 and to one or more of the components, or inputting a dedicated identifying element 42 of a kit 10 component, for example, a permanent serial number of the rental casket 50, into the work order manually, by scanning, or otherwise, to associate that component element with the order number and/or casket kit 10 identifier. Step 76 may include customization of the rental casket kit 10, which may include installing a lid panel 16, assembling customized trim to the rental casket 50, which may include hardware such as inlays 34, swing arm mounts 30, swing arms, corner elements 32, etc. The fulfillment step 76 may include assembling the rental casket 50 unit for efficient shipment, which may include installing the lid panel 16 in the lid 14, packaging the pillow 24, lining 26, overlay 20 and drop 22 in the casket insert 40 and inserting the casket insert 40 into the rental casket 50. During step 76 or alternatively, in delivery step 78 the rental casket kit 10 may be wrapped, blanketed, or otherwise protected for transport, and/or placed on a skid or support for movement during transport (not shown). Some or all of the packaging materials (not shown) including wrapping, skids, etc., may be reusable and/or recyclable.

At delivery step 78 the assembled rental casket kit 10 is delivered by the distributor Dx to the provider Px. The order status and inventory status of the rental casket 50 and casket kit 10 components may be updated to “in transit outbound,” or the like, in the ERP system 64. The rental casket kit 10 may be transported by any appropriate means for delivery to the provider Px, which may include, by non-limiting example, transport of the rental casket kit 10 by a distributor's truck, pick-up and transport by the provider's truck, transport by common carrier, transport by rail, etc. Upon acceptance of the delivered rental casket kit 10 by the provider Px, the order status may be updated in the ERP system 64 to indicate “delivered” and the inventory status of the rental casket 50 and returnable components contained therein may be updated to “rented” or “in use.” The inventory status of consumable, e.g., non-returnable components of the delivered rental casket 50 components may be updated by one or more of relieving the available inventory of the shipped quantity of non-returnable component, updating a demand forecast, releasing a purchasing order to a supplier Sx for replenishment of that component, etc., where replenishment ordering of consumable components may occur automatically. The demand forecast may be used to analyze usage trends and may include reports where orders were diverted to a secondary distributor or modified due to lack of availability, such that the demand forecast information may be used to periodically adjust and/or recommend adjustment of the in stock number and/or model mix of rental caskets 50 maintained in inventory at each distributor Dx in the distributor network 52.

Continuing to notification step 80, the provider Px, preferably during the rental period, notifies the distributor Dx and administrator 48 of the estimated availability of the rental casket 50 for pick-up by the distributor Dx. In a typical scenario, the rental fee may provide for a rental period of up to ten days including the delivery date of the rental casket kit 10 to the provider Px, where preferably a rental period of one to five (1 to 5) rental days is provided, with a requirement that the rental casket 50 be made available for return and pick-up within one (1) day after the rental period, or within one (1) day after the provider Px has advised the distributor Dx of the estimated availability date for pick-up. By way of non-limiting example, the distributor Dx will pick-up the rental casket 50 being returned within ten (10) days of the pick-up availability date, and preferably will pick-up the returning rental casket 50 within five business days of the pick-up availability date, such that the rental casket 50 can be inspected and dispositioned and/or cleaned and restocked to be available for assembly into another rental casket kit for re-rental, and such that the provider Px is only required to store the rental casket 50 for a limited period of time after use, e.g., after the rental period.

As shown in FIG. 4, the provider Px, may, as an alternative to returning the rental casket 50 after the rental period, elect to re-rent the rental casket 50 for another use. In this event, the provider Px may notify the distributor Dx at step 80 of the intent to re-rent the rental casket 50 for use by a second client deceased C2, and at step 94 the ERP system 64 may be updated to include a second order for re-rental of the rental casket 50, where the second order may, at step 96, including processing an order for a second set of consumable components including a casket insert 40, lining 26, pillow 24, drop 22, overlay 20, etc. for presentation of the second client deceased C2 in the rental casket 50. Step 96 proceeds similarly to steps 70 through 78, for the consumable components only, with generation and confirmation of a consumables order, dispatch to the distributor Dx, and fulfillment and delivery at step 98 of the consumables order to the provider Px within the delivery objective. The casket kit 10 rental fee for the second rental of the rental casket 50 already in the provider Px's possession may include a second rental fee, the price of the consumables order, e.g., the price of the second casket insert 40, pillow 24, overlay 20, etc., and any additional fees, for example, for expedited delivery, etc. The provider Px's first rental casket deposit is held on account such that an additional or second rental casket deposit is not required or included in the second casket 50 rental kit 10 price. Following the second rental the method 100 returns and the provider Px provides notification to the distributor Dx that the rental casket 50 is available for pick-up. Alternatively, the provider Px may re-rent the rental casket 50 for a third time, and the method 100 continues again through steps 94 through 98, returning to step 80.

Another option is shown at step 80, where the provider Px notifies the distributor Dx of the intent to purchase the rental unit. At step 90, a purchase order for the rental unit is processed through the ERP system 64, and the provider Px is invoiced, for example, for any difference between the purchase price of the rental casket 50 and the rental casket kit 10 deposit previously received from the provider Px. The ERP system 64 may be updated to show the rental casket 50, which may be identified by a serial number, for example, as “purchased” and further updated at step 92 to replenish the distributor Dx's inventory with a replacement rental casket 50, where replenishment may include the ERP system 64 automatically generating a purchase order to a supplier Sx for replacement of the purchased rental casket 50. In another example, the rental casket 50 may be sold to the provider Px upon failure of the provider Px to return the rental casket 50 to the distributor Dx during the return period or within a reasonable time thereafter, with the rental casket kit 10 deposit being retained by the distributor Dx in at least partial payment of the purchase price of the rental casket 50. The ERP system 64 may automatically flag a non-returned rental casket 50 when the “rented” status extends beyond a set time limit in the ERP system 64, for review of the rental casket 50 status, and/or to initiate automatic sale of the rental casket 50 to the provider Px still in possession of that rental casket 50.

Returning again to step 80, upon notification of availability of the used rental casket 50 for pick-up by the distributor Dx, the used rental casket 50 is returned at step 82. The example of the distributor Dx picking up the used rental casket 50 from the provider Px is non-limiting, and other means of transportation, include return of the rental casket 50 to the distributor Dx by the provider Px, or by common carrier, may be used. Upon return to the distributor Dx at step 82, the status of the rental casket 50 in the ERP system 64 may be updated to “inspection” status.

Continuing with step 84, the returned rental casket 50 is inspected. Inspection of the returned rental casket 50 may include inspection for missing parts including rental casket 50 hardware and lid panels 16, inspection for damage including scratches, dents, dings, abrasion, or other damage affecting the appearance and/or functionality of the rental casket 50, inspection of the lid panel 16 and/or cleaning of the lid panel 16, inspection of the trim components of the rental casket 50 including swing bars 28, swing bar mounts 30, corner elements 32, inlays 34 or other decorative trim or embellishment 18. Step 84 may include cleaning of the rental casket 50 in preparation for reuse, e.g., re-renting the rental casket 50 for subsequent use. Step 84 may further include inputting the inspection results into the ERP system 64, where the inspection results may include a repair or additional cleaning estimate and a description of the repair or refurbishing required, for inclusion with a final accounting of the rental order at step 86. Step 84 may include updating the rental casket 50 inventory status in the ERP system 64 based on the condition of the casket 50. For example, the inventory status of a rental casket 50 with no damage and cleaned in the inspection process may be updated to “in stock/available.” The inventory status of a returned rental casket 50 with repairable damage may be updated to “refurbish” and an estimated availability date entered into the ERP system 64 based on the extent of the repairs which must be completed. The inventory status of a severely damaged, e.g., irreparable, rental casket 50 may be updated to “scrapped,” where the ERP system 64 may automatically generate a purchase order to a supplier Sx to requisition a replacement rental casket 50. In the event components are missing from the rental casket 50, such as a lid panel 16 or trim hardware, the estimated replacement cost to be charged to the responsible provider Px may be entered into the accounting portion of the inspection module, and the inventory quantity of the missing components adjusted in the database 68, which may generate a replenish purchase order to a supplier Sx to supply the missing components.

Accounting step 86 includes making adjustments to the rental casket kit price, for example, for damage, cleaning, or missing component fees, and for any other fees, for example, late fees assessed in the event the rental casket 50 was not available for pick-up within the return period, and a final accounting is produced for the order. Based on the final accounting, a credit for the amount of rental casket kit 10 deposit in excess of assessed fees and adjustments is issued to the provider Px, or in the event of a severely damaged or non-returned rental casket 50, where the assessed fees and/or repair or replacement costs of the unit may exceed the amount of the rental casket kit 10 deposit, an invoice and/or debit is issued to the provider Px in the amount owed to the distributor in excess of the rental casket kit 10 deposit, and the rental casket kit 10 deposit is retained by the distributor in partial payment of the assessed fees and/or repair and replacement costs.

Disposition step 88 includes disposition of the returned casket 50, which may include, for example, restocking the rental casket 50 in the distributor inventory and updating the rental casket 50 status in the ERP system 64 to “in stock/available” after any required cleaning and/or repairs are complete, repairing the rental casket 50 prior to restocking, refurbishing the rental casket 50 prior to restocking, for example, by replacing missing or worn components, or scrapping the rental casket 50 if determined to be irreparable.

The method 100 shown in FIG. 4 is non-limiting and other configurations, combinations of steps, etc. may be used. For example, the distribution system 60 including the administrative system 48 and ERP system 64 may be arranged such that inventory movement and transfer occurs between multiple distributors D1, D2 (by illustrative example) in the distributor network 52 during execution of an order for a rental casket kit 10, for the convenience of the service provider Px and/or for efficiencies in the operation of the distribution network 52. For example, an order for a rental casket kit 10 may be dispatched to a fulfilling distributor D1 based on availability of the ordered rental casket 50 at the distributor D1. Fulfilling distributor D1 assembles and delivers the rental casket kit 10 to the provider Px and is credited for the rental casket deposit received from the provider Px. Upon completion of use, a second distributor D2 may pick-up the returning rental casket 50, for example, where the second distributor D2 is the primary distributor to the provider Px and/or where the second distributor D2 is located closer to the provider Px than the fulfilling distributor D1. The second distributor D2 may then perform the inspection function and enter inspection results into the ERP system 64. The returned rental casket 50 may be dispositioned for cleaning and/or repair which may be performed by the second distributor D2 prior to transport of the rental casket 50 from the returning distributor D2 to the fulfilling distributor D1. In this event, the ERP system 64 provides for crediting the returning distributor D2 for a portion of the rental fee originally credited to the fulfilling distributor D1, for pick-up, inspection, and cleaning/repair of the returned rental casket 50. The returned rental casket 50, after cleaning/repair, may either be transported to the fulfilling distributor D1 for restocking until next rental, or retained by the returning distributor D2 and the inventory transferred from distributor D1 to distributor D2 in the ERP system 64 and database 68, with appropriate credits and debits being made for the asset transfer.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method for distributing a rental casket kit, the method comprising:
receiving an order from a service provider for rental of a rental casket kit comprising a reusable rental casket;
receiving a rental casket kit price comprising a rental fee and a rental casket deposit from an administrative system;
assembling the rental casket into the rental casket kit; and
delivering the rental casket kit to the service provider.

2. The method of claim 1, further comprising:
retrieving the rental casket from the service provider;
inspecting the returned rental casket to determine the returned condition of the rental casket;
refurbishing the returned rental casket;
wherein refurbishing the returned rental casket includes at least one of cleaning and repairing the rental casket; and
determining a portion of the rental casket deposit refundable to the service provider based on the returned condition of the rental casket.

3. The method of claim 1, further comprising:
monitoring a rental casket inventory within a distributor network;
determining availability of the ordered rental casket within the distributor network;
selecting a fulfilling distributor from the distributor network based on the availability of the rental casket from rental casket inventory of the fulfilling distributor.

4. The method of claim 1, further comprising:
wherein the rental casket kit further comprises a non-reusable casket insert;
assembling a non-reusable casket insert into the rental casket kit; and
delivering the rental casket kit including the casket insert to the service provider.

5. The method of claim 1, further comprising:
wherein the rental casket kit comprises a non-reusable component;
assembling the non-reusable component into the rental casket kit; and
delivering the rental casket kit including the non-reusable component to the service provider.

6. The method of claim 5, wherein the non-reusable component is one of a casket lining, a casket pillow, and a casket overlay.

7. The method of claim 1, the method further comprising:
wherein the rental casket is a customized rental casket;
providing a rental casket kit price comprising a customization fee; and
customizing the rental casket to provide a customized rental casket.

8. The method of claim 1, wherein customizing the rental casket comprises modifying the rental casket to customize at least one of a swing bar, a swing bar mount, a corner element, and an inlay of the rental casket.

9. The method of claim 1, further comprising:
receiving the order from the service provider via a network in communication with an administrative system comprising an ERP system; and
administering the order using the ERP system.

10. The method of claim 9, further comprising:
associating an inventory status identifier with the rental casket in the ERP system; and
modifying the inventory status identifier of the rental casket to indicate completion of at least one of order dispatch, order delivery, rental casket return, and rental casket inspection.

11. The method of claim 9, further comprising:
wherein the rental casket kit comprises a non-reusable component;
assembling the non-reusable component to the rental casket kit;
delivering the rental casket kit including the non-reusable component to the service provider;
associating an inventory quantity with the non-reusable component in the ERP system; and
modifying the inventory quantity of the non-reusable component to indicate delivery of the non-reusable component to the service provider.

12. A system for distributing a rental casket kit, the system comprising:
a distributor network in communication with an administrative system and a service provider;
the distribution network to perform a method comprising:
receiving an order from a service provider for rental of a rental casket kit comprising a reusable rental casket;
receiving a rental casket kit price comprising a rental fee and a rental casket deposit from an administrative system;
assembling the rental casket into the rental casket kit; and
delivering the rental casket kit to the service provider.

13. The system of claim 12, the method further comprising:
retrieving the rental casket from the service provider;
inspecting the returned rental casket to determine the returned condition of the rental casket;
refurbishing the returned rental casket;
wherein refurbishing the returned rental casket includes at least one of cleaning and repairing the rental casket; and
determining a portion of the rental casket deposit refundable to the service provider based on the returned condition of the rental casket.

14. The system of claim 12, the method further comprising:
determining availability of the rental casket within a distributor network;
selecting the fulfilling distributor from the distributor network based on the availability of the rental casket from the fulfilling distributor.

15. The system of claim 12, the method further comprising:
wherein the rental casket kit further comprises a non-reusable casket insert;
assembling a non-reusable casket insert into the rental casket kit; and
delivering the rental casket kit including the casket insert to the service provider.

16. The system of claim 12, further comprising:
the distributor network in communication with an ERP system;
the method further comprising:
receiving the order from the service provider via a network in communication with the ERP system; and
administering the order using the ERP system.

17. The system of claim 12, further comprising:
a supplier network in communication with the administrative system;
wherein in response to receipt of an order for a rental casket kit the administrative system generates a replenishment order to a supplier in the supplier network.

18. A computer-readable memory device comprising instructions for causing a computer to implement steps in a method for distributing a rental casket kit, the method comprising:
the distribution network to perform a method comprising:
receiving an order from a service provider for rental of a rental casket kit comprising a reusable rental casket;
receiving a rental casket kit price comprising a rental fee and a rental casket deposit from an administrative system;
assembling the rental casket into the rental casket kit;
delivering the rental casket kit to the service provider;
retrieving the rental casket from the service provider;
inspecting the returned rental casket to determine the returned condition of the rental casket;
refurbishing the returned rental casket;
wherein refurbishing the returned rental casket includes at least one of cleaning and repairing the rental casket; and
determining a portion of the rental casket deposit refundable to the service provider based on the returned condition of the rental casket.

19. The computer-readable memory device of claim 18, further comprising:
associating an inventory status identifier with the rental casket in an ERP system in communication with the distributor; and
modifying the inventory status identifier of the rental casket to indicate completion of at least one of order dispatch, order delivery, rental casket return, and rental casket inspection.

20. The computer-readable memory device of claim 19, further comprising:
wherein the rental casket kit comprises a non-reusable component;
associating an inventory quantity with the non-reusable component in the ERP system; and
modifying the inventory quantity of the non-reusable component to indicate delivery of the non-reusable component to the service provider.
